(19) United States
(12) Patent Application Publication
(10) Pub. No.: US 2026/0065466 A1
(43) Pub. Date: Mar. 5, 2026

(54) INSPECTION SYSTEM AND CONTROL METHOD THEREOF

(71) Applicant: CANON KABUSHIKI KAISHA, Tokyo (JP)

(72) Inventor: TAKASHI YABE, Chiba (JP)

(21) Appl. No.: 19/310,233

(22) Filed: Aug. 26, 2025

(30) Foreign Application Priority Data
Aug. 30, 2024 (JP) 2024-150232

(51) Int. Cl. G06T 7/00; G03G 15/00

(52) U.S. Cl. CPC G06T 7/001; G03G 15/5016; G03G 15/55; G06T 2207/30144

(57) ABSTRACT

The present disclosure is directed to inspection system including a controller that, in an inspection of comparing a captured image obtained by capturing a print product generated by an image formation device and a reference image, determines whether the captured image is normal or a failure, the system comprising a display I/F that, in a state in which a quality of the print product by the image formation device degrades even in a case where a result of the inspection is normal, announces occurrence of the state and a count at which the state has occurred.

### BACKGROUND

### Field of the Technology

The present disclosure relates to an inspection system and a control method thereof.

### Description of the Related Art

There is known an image formation apparatus that detects an abnormality from a formed image and identifies the part that is a factor in the abnormality (factor part) from the detected abnormality (for example, Japanese Patent Laid-Open No. 2021-164105). An image formation apparatus including a capturing unit can capture an image formed on a sheet output from the apparatus to detect an abnormality included in the image and identify the part that is a factor in the abnormality. Such an image formation apparatus performs maintenance work before a trouble of the image formation apparatus actually occurs, and thus can also diagnose the precursor of an unacceptable abnormality by strictly setting the abnormality detection level. Japanese Patent Laid-Open No. 2021-164105 proposes an image formation apparatus that corrects an abnormality upon detecting the abnormality.

It is conceivable that the precursor of an abnormality detected in the above-mentioned image formation apparatus is displayed on a screen. However, the user who sees the screen may not be able to recognize the degree of a precursor and thus may not execute correction, cleaning, and the like of a part. In such a case, an abnormality exceeding the criterion may be detected in product inspection in the next job, and an image-formed medium or the like may be wastefully discarded.

### SUMMARY

The present disclosure enables realization of a new mechanism that allows a user to recognize the degree of the precursor of an abnormality when the abnormality of an image is detected in an image formation apparatus.

One aspect of the present disclosure provides an inspection system including a controller that, in an inspection of comparing a captured image obtained by capturing a print product generated by an image formation device and a reference image, determines whether the captured image is normal or a failure, the system comprising a display I/F that, in a state in which a quality of the print product by the image formation device degrades even in a case where a result of the inspection is normal, announces occurrence of the state and a count at which the state has occurred.

Another aspect of the present disclosure provides a control method of an inspection system including a controller that, in an inspection of comparing a captured image obtained by capturing a print product generated by an image formation device and a reference image, determines whether the captured image is normal or a failure, the method comprising displaying, in a state in which a quality of the print product by the image formation device degrades even in a case where a result of the inspection is normal, a notification of occurrence of the state and a count at which the state has occurred.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic view of a printing system according to an embodiment;

FIG. 2 is a sectional view of an image formation apparatus according to the embodiment;

FIG. 3 is a functional block diagram of a printing system according to the embodiment;

FIG. 4 shows a display screen of the image formation apparatus according to the embodiment;

FIG. 5 shows a display screen of the image formation apparatus according to the embodiment;

FIGS. 6A and 6B are flowcharts of processing according to the embodiment;

FIG. 7 is a table for explaining a detection size according to the embodiment;

FIG. 8 is a table for explaining a detection size according to the embodiment;

FIG. 9 shows a display screen of the image formation apparatus according to the embodiment;

FIG. 10 is a table for explaining correction contents according to the embodiment;

FIG. 11 shows a display screen of the image formation apparatus according to the embodiment;

FIG. 12 shows a display screen of the image formation apparatus according to the embodiment;

FIG. 13 shows a display screen of the image formation apparatus according to the embodiment;

FIG. 14 shows a display screen of the image formation apparatus according to the embodiment;

FIG. 15 shows a display screen of the image formation apparatus according to the embodiment;

FIGS. 16A and 16B are flowcharts of processing according to an embodiment;

FIG. 17 shows a display screen of the image formation apparatus according to the embodiment;

FIG. 18 shows a display screen of the image formation apparatus according to the embodiment;

FIG. 19 shows a display screen of the image formation apparatus according to the embodiment;

FIG. 20 shows a display screen of the image formation apparatus according to the embodiment;

FIGS. 21A to 21F are views for explaining an abnormality pattern according to the embodiment;

FIG. 22 is a view for explaining an abnormality pattern according to the embodiment; and FIG. 23 is a table for explaining a counter according to the embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In this specification, a term “image formation apparatus” broadly includes apparatuses that form (print) an image on a print member (also called a print medium, a sheet, or paper), such as a single-function printer, a copying machine, a multifunction printer, and a commercial printing machine. Note that in an image formation apparatus to be described later, the maximum size of a feedable sheet is the length of an A3 sheet in the conveyance direction and the width of the A3 sheet in a direction perpendicular to the conveyance direction (the image formation apparatus will be also referred to as an A3 machine hereinafter). When forming an image on a sheet, a case where the long side of a sheet is arranged parallel to the conveyance direction of the sheet will be referred to as a case where the conveyance direction of the sheet is lateral, and a case where the short side of a sheet is arranged parallel to the conveyance direction of the sheet will be referred to as a case where the conveyance direction of the sheet is longitudinal. Note that as a sheet, various sheet members of different sizes and materials are available, including paper such as plain paper or thick paper, a surface-treated sheet member such as coated paper, a plastic film, cloth, and a sheet member of a special shape such as an envelope or an index sheet.

### First Embodiment

### Overall Configuration of System

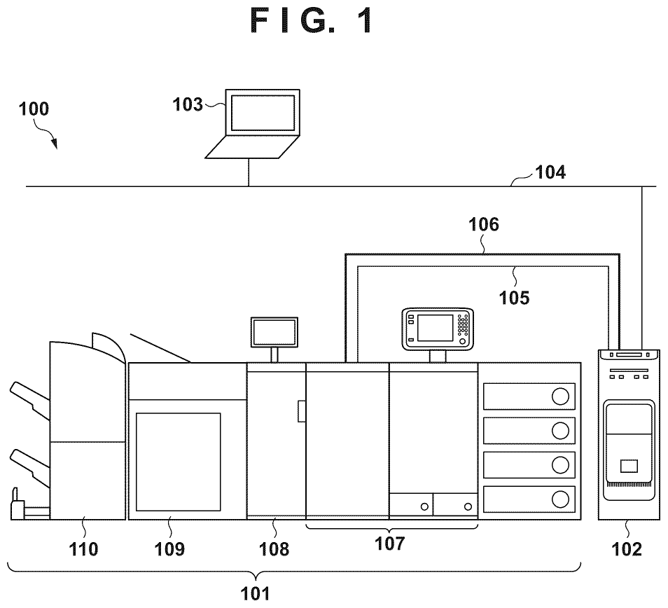

FIG. 1 is a view showing an example of a network configuration including a printing system 100 (image processing system) according to the first embodiment. As shown in FIG. 1, the printing system 100 includes an image formation apparatus 101 and an external controller 102. The image formation apparatus 101 and the external controller 102 are connected in a communication-enabling manner via an internal LAN 105 and a video cable 106. The external controller 102 is connected in a communication-enabling manner to a client PC 103 via an external LAN 104.

The client PC 103 can issue a print instruction to the external controller 102 via the external LAN 104. A printer driver having a function of converting image data subjected to print processing into a Page Description Language (PDL) processible by the external controller 102 is installed in the client PC 103. A user who wants to print can operate the client PC 103 to issue a print instruction via the printer driver from various applications installed in the client PC 103. Based on the print instruction from the user, the printer driver transmits PDL data serving as print data to the external controller 102. Upon receiving the PDL data from the client PC 103, the external controller 102 analyzes and interprets the received PDL data. The external controller 102 performs rasterization processing based on the result of the interpretation, generates a bitmap image (print image data) of a resolution conforming to the image formation apparatus 101, and inputs a print job to the image formation apparatus 101, thereby issuing a print instruction.

Next, the image formation apparatus 101 will be explained. The image formation apparatus 101 is configured by connecting devices having a plurality of different functions so that complicated print processing such as bookbinding is possible. That is, the image formation apparatus 101 includes a printing device 107 (image formation device), a diagnosis device 108, a stacker 109, and a finisher 110. Each module will be explained below. Note that the diagnosis device 108 is an example of “diagnose”.

The printing device 107 prints an image in accordance with a print job, and discharges the printed print member (sheet). The printed print member discharged from the printing device 107 is conveyed inside the respective devices in the order from the diagnosis device 108, the stacker 109, and the finisher 110. Although the image formation apparatus 101 of the printing system 100 is an example of the image formation apparatus in this embodiment, the printing device 107 included in the image formation apparatus 101 is sometimes called an image formation apparatus. The printing device 107 forms (prints) an image by using toner (color material) on a print member fed and conveyed from a sheet feeding device arranged at the lower portion of the printing device 107.

The diagnosis device 108 is an image diagnosis apparatus that diagnoses the presence/absence of an abnormal portion of the image formation apparatus 101 based on a printed print member on which an image has been printed by the printing device 107 and which has been conveyed through a conveyance path. More specifically, the diagnosis device 108 captures the image printed on the conveyed printed print member, and executes a diagnosis from the captured image. An abnormality is diagnosed by extracting a diagnosis region from the captured image, and checking a capture signal value difference within the extracted diagnosis region. Detailed processing of the diagnosis device will be described later. Note that the diagnosis device is used at the time of product inspection and at the time of precursor diagnosis. The diagnosis device is also a device that inspects the failure of a printed print member or the presence/absence, size, or degree of an abnormality of the image quality based on a comparison between print data and data of a printed print member on which the image has been printed by the printing device 107 and which has been conveyed through the conveyance path.

The stacker 109 is a device capable of stacking many printed print members. The finisher 110 is a device capable of executing finishing processing including stapling processing, punching processing, and saddle stitching processing on a conveyed printed print member. The print member processed by the finisher 110 is discharged to a predetermined discharge tray.

Note that in the configuration example of FIG. 1, the external controller 102 is connected to the image formation apparatus 101, but the embodiment is applicable to even a configuration different from this configuration example. For example, a configuration may be adopted in which the image formation apparatus 101 is connected to the external LAN 104, and print data is transmitted from the client PC 103 to the image formation apparatus 101 without the intervention of the external controller 102. In this case, data analysis and rasterization of print data may be executed by the image formation apparatus 101.

### Hardware Configuration of Image Formation Apparatus 101

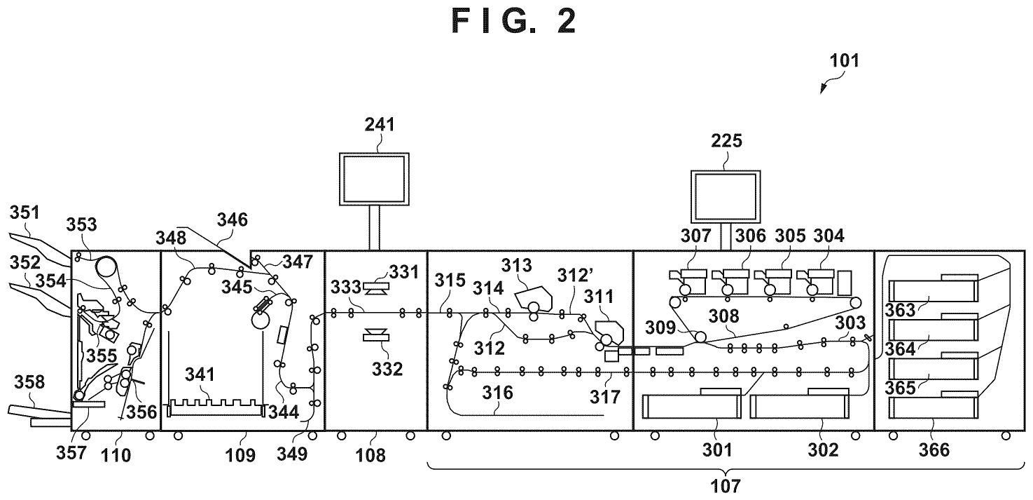

A detailed operation example of the image formation apparatus 101 will be explained with reference to FIG. 2.

### Explanation of Sheet Deck

The printing device 107 includes, for example, six types of sheet decks 361, 362, 363, 364, 365, and 366. Various print members are stored in the respective sheet decks. Print members stored in each sheet deck are separated one by one from the top print member, and fed to a conveyance path 303. Each of image formation stations 304 to 307 includes a charging device, an exposure device, and a photosensitive drum (photosensitive member). In the image formation stations 304 to 307, the photosensitive drums are charged by the charging devices and exposed by the exposure devices to form toner images of respective colors on the photosensitive drums using toners of colors different between the respective stations. More specifically, the image formation stations 304 to 307 form toner images of the respective colors using yellow (Y), magenta (M), cyan (C), and black (K) toners.

The toner images of the respective colors formed in the image formation stations 304 to 307 are sequentially overlaid and transferred onto an intermediate transfer belt 308 (primary transfer). The toner image transferred onto the intermediate transfer belt 308 is conveyed to a secondary transfer position 309 along with rotation of the intermediate transfer belt 308. At the secondary transfer position 309, the toner image is transferred from the intermediate transfer belt 308 to a print member conveyed through the conveyance path 303 (secondary transfer). The print member after secondary transfer is conveyed to a fixing unit 311. The fixing unit 311 includes a pressurizing roller and a heating roller. Fixing processing is performed to fix the toner image to the print member by applying heat and a pressure to the print member while the print member passes between these rollers. The print member having passed through the fixing unit 311 passes through a conveyance path 312 and is conveyed to a connection point 315 between the printing device 107 and the diagnosis device 108. In this manner, the color image is formed (printed) on the print member.

When further fixing processing is necessary depending on the type of print member, the print member having passed through the fixing unit 311 is guided to a conveyance path 314 on which a fixing unit 313 is provided. The fixing unit 313 performs further fixing processing on the print member conveyed through the conveyance path 314. The print member having passed through the fixing unit 313 is conveyed to the connection point 315. When an operation mode in which double-sided printing is performed is set, the print member on which the image has been printed on the first surface and which has been conveyed through the conveyance path 312 or the conveyance path 314 is guided to a reverse path 316. The print member reversed through the reverse path 316 is guided to a double-sided conveyance path 317 and conveyed to the secondary transfer position 309. At the secondary transfer position 309, a toner image is transferred to the second surface of the print member opposite to the first surface. After that, the print member passes through the fixing unit 311 (and the fixing unit 313), thus completing the formation of the color image on the second surface of the print member.

Upon completion of the formation (printing) of the image in the printing device 107, the printed print member conveyed to the connection point 315 is conveyed into the diagnosis device 108. The diagnosis device 108 includes image capturing units 331 and 332 each having a Contract Image Sensor (CIS) on a conveyance path 333 through which the printed print member from the printing device 107 is conveyed. The image capturing units 331 and 332 are arranged at positions where they face each other via the conveyance path 333. The image capturing units 331 and 332 are configured to capture images on the upper surface (first surface) and lower surface (second surface) of a print member, respectively. Note that the image capturing unit may be constituted by a Charge Coupled Device (CCD) or a line scan camera, instead of the CIS.

The diagnosis device 108 performs various image diagnosis processes of the image formation apparatus 101 based on an image printed on a printed print member conveyed through the conveyance path 333. More specifically, at the timing when a printed print member during conveyance reaches a predetermined position, the diagnosis device 108 performs capture processing using the image capturing units 331 and 332 to capture the image of the printed print member. By using the captured image, the diagnosis device 108 performs, for example, product inspection diagnosis of inspecting the abnormality of an output product during printing, and precursor diagnosis of diagnosing the precursor of an abnormality. In this embodiment, the “abnormality” is an abnormality unacceptable in regard to the quality level, and the “precursor” is a preliminary abnormality that can be an unacceptable abnormality in the future. An image diagnosis method is employed for these diagnoses. Also, the diagnosis device 108 identifies a factor of a precursor or abnormality from the diagnosis result of the product inspection diagnosis or precursor diagnosis, and causes the printing device 107 to execute processing of correcting the part of the factor. Note that the product inspection diagnosis is a diagnosis of detecting an abnormality, for example, whether there is a failure in a printed print product or whether an image not contained in printing target original data has been printed.

The precursor diagnosis is a diagnosis in which a precursor considered to be an abnormality in the future is detected, but need not be corrected immediately after the diagnosis. The precursor diagnosis is made basically for a print image during printing by the user. The image diagnosis is a diagnosis in which an abnormality is detected and the detected abnormality is quickly corrected. The image diagnosis is performed basically during the stop of printing. When the image diagnosis is performed by the single image formation apparatus 101, an image diagnosis chart is printed and the diagnosis is made using the printed image. Also, when an abnormality is detected on a print product in product inspection, the image diagnosis is used to analyze a factor in the abnormality.

Print members having passed through the diagnosis device 108 are sequentially conveyed to the stacker 109. The stacker 109 includes a stacker tray 341. On the stacker tray 341, printed print members conveyed from the diagnosis device 108 arranged upstream in the conveyance direction of the printed print members are stacked. The printed print members having passed through the diagnosis device 108 pass through a conveyance path 344 in the stacker 109. The printed print members having passed through the conveyance path 344 are guided to a conveyance path 345 and stacked on the stacker tray 341.

The stacker 109 further includes an escape tray 346 as a discharge tray. In this embodiment, the escape tray 346 is used to discharge a print member on which a test chart used for image diagnosis by the diagnosis device 108 is printed. The printed print member having passed through the conveyance path 344 is guided to a conveyance path 347 and conveyed to the escape tray 346. A printed print member conveyed without being stacked and discharged in the stacker 109 is conveyed to the subsequent finisher 110 through a conveyance path 348. The escape tray 346 is also used to discharge a printed print member determined to have a failure/abnormality in product inspection diagnosis by the diagnosis device 108 so that the printed print member is discriminated from normally printed print members.

The stacker 109 further includes a reversing unit 349 for reversing the orientation of a conveyed printed print member. The reversing unit 349 is used to, for example, make the orientation of a print member input to the stacker 109 coincide with the orientation of a printed print member that is stacked on the stacker tray 341 and is to be output from the stacker 109. Note that the reversing operation by the reversing unit 349 is not performed on a printed print member that is conveyed to the finisher 110 without being stacked in the stacker 109.

The finisher 110 executes a finishing function designated by the user on printed print members conveyed from the diagnosis device 108 arranged upstream in the conveyance direction of the printed print members. In this embodiment, the finisher 110 has finishing functions such as a stapling function (1-or 2-point stapling), a punching function (two or three holes), and a saddle stitching function. The finisher 110 includes two discharge trays 351 and 352. When no finishing processing by the finisher 110 is performed, printed print members conveyed to the finisher 110 are discharged to the discharge tray 351 through a conveyance path 353. When finishing processing such as stapling processing is performed by the finisher 110, printed print members conveyed to the finisher 110 are guided to a conveyance path 354. The finisher 110 executes finishing processing designated by the user on printed print members conveyed through the conveyance path 354 by using a finishing processing unit 355, and discharges, to the discharge tray 352, the printed print members having undergone the finishing processing.

### Functional Configuration View

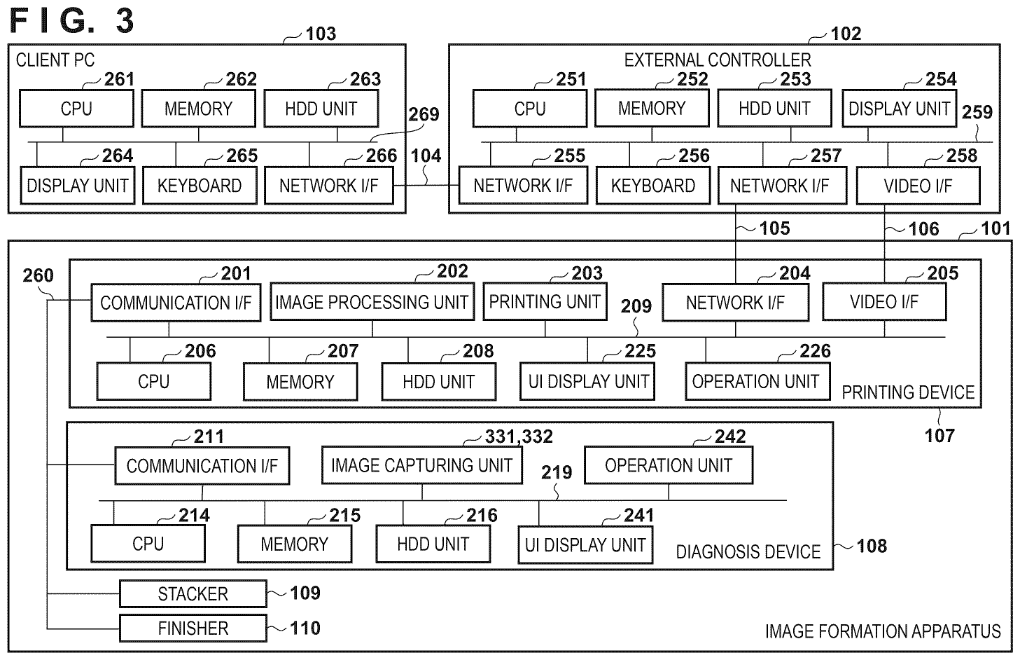

FIG. 3 is a functional block diagram of the image formation apparatus 101, the external controller 102, and the client PC 103.

### Image Formation Apparatus 101

The printing device 107 of the image formation apparatus 101 includes a communication interface (I/F) 201, a network I/F 204, a video I/F 205, a CPU 206, a memory 207, an HDD 208, a UI display unit 225, and an operation unit 226. The printing device 107 further includes an image processing unit 202 and a printing unit 203. These devices are connected so that they can transmit/receive data to/from each other via a system bus 209.

The communication I/F 201 includes a communication module, and is connected to the diagnosis device 108, the stacker 109, and the finisher 110 via a communication cable 260. The CPU 206 performs communication for controlling the respective devices via the communication I/F 201. The network I/F 204 further includes a communication module such as Network Interface Card (NIC), is connected to the external controller 102 via the internal LAN 105, and is used for communication of control data and the like. The video I/F 205 includes a video module and the like, is connected to the external controller 102 via the video cable 106, and is used for communication of data such as image data. Note that the printing device 107 (image formation apparatus 101) and the external controller 102 may be connected by only the video cable 106 as far as the operation of the image formation apparatus 101 can be controlled by the external controller 102.

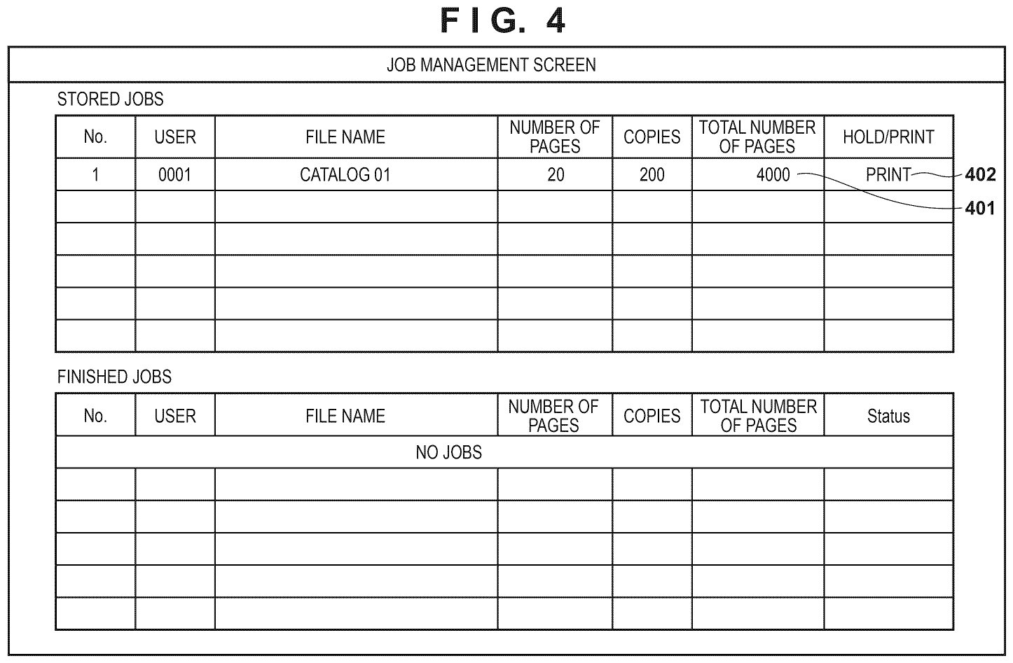

In the HDD 208, various programs or data are stored. The CPU 206 controls the operation of the overall printing device 107 by executing a program stored in the HDD 208. In the memory 207, programs and data necessary when the CPU 206 performs various processes are stored. The memory 207 operates as the work area of the CPU 206. The UI display unit 225 includes, for example, a touch panel display, accepts input of various settings and an operation instruction from the user, and is used for display of print job management. For example, the UI display unit 225 can display a job management screen shown in FIG. 4, and allow the user to perform a touch operation, a slide operation, or the like for confirming or changing a print job. The operation unit 226 includes, for example, the touch panel display, buttons, and the like, and accepts a change of settings of the printing device 107, and a touch operation, a slide operation, or the like for designating execution of various diagnoses.

The diagnosis device 108 includes a communication I/F 211, a CPU 214, a memory 215, an HDD 216, the image capturing units 331 and 332, a UI display unit 241, and an operation unit 242. These devices are connected so that they can transmit/receive data to/from each other via a system bus 219. The communication I/F 211 includes a communication module, and is connected to the printing device 107 via the communication cable 260. The CPU 214 performs communication necessary for controlling the diagnosis device 108 via the communication I/F 211. The CPU 214 controls the operation of the diagnosis device 108 by executing a control program stored in the memory 215. In the memory 215, control programs for the diagnosis device 108 are stored. Each of the image capturing units 331 and 332 includes, for example, a scanner, and captures an image in accordance with an instruction from the CPU 214. In various diagnoses, the CPU 214 diagnoses the presence/absence of an abnormal portion of the image formation apparatus 101 based on an image for diagnosis captured by the image capturing units 331 and 332. Especially in product inspection diagnosis, the CPU 214 captures, via the image capturing units 331 and 332, a print member printed in the image formation apparatus 101, and inspects the failure (abnormality) of the printed print member based on the captured image.

The UI display unit 241 includes, for example, a touch panel display, and is used to display the results of various diagnoses, an automatic correction execution state based on the diagnosis results, a setting screen, and the like. The operation unit 242 includes the touch panel display, and accepts a change of settings of the diagnosis device 108, and a touch operation, a slide operation, or the like for designating execution of various diagnoses.

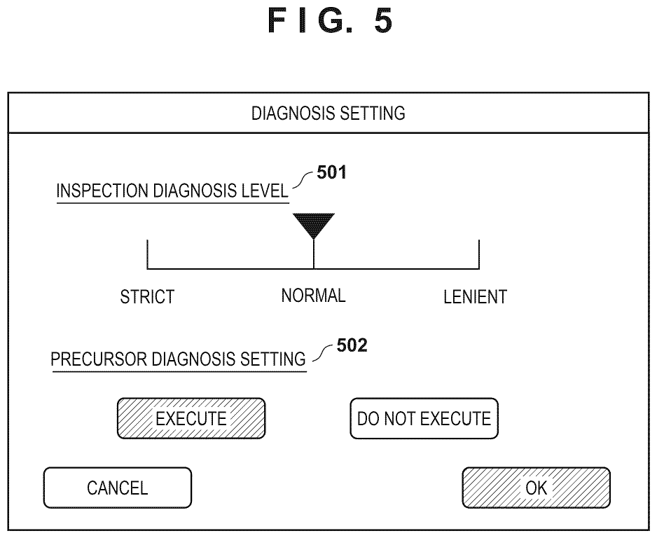

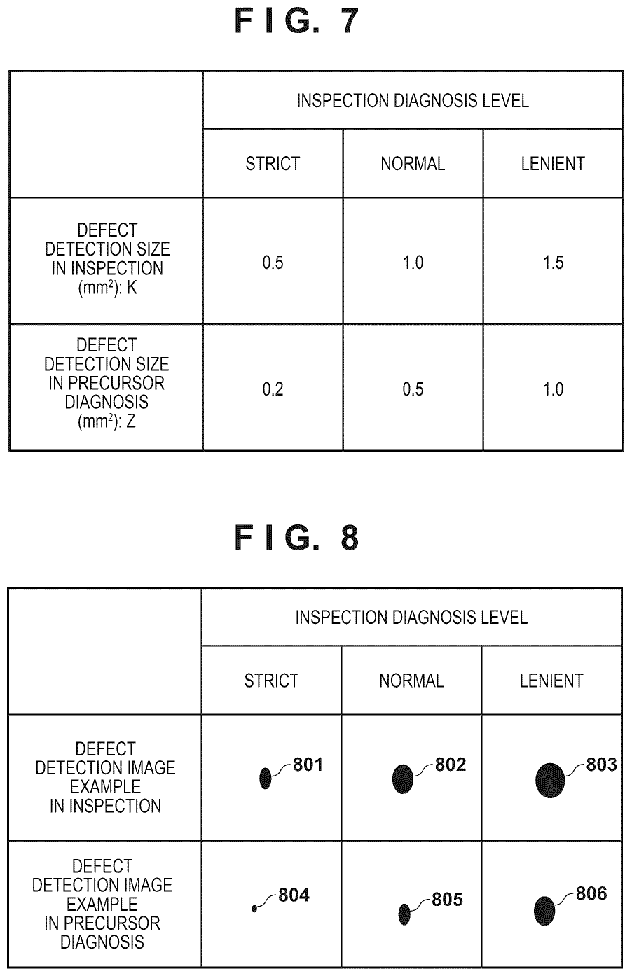

A diagnosis setting screen displayed on the UI display unit 241 of the diagnosis device 108 will be explained with reference to FIG. 5. On the diagnosis setting screen, a product inspection diagnosis level 501 and a precursor diagnosis level 502 can be set. In the example shown in FIG. 5, the product inspection diagnosis level 501 is set to be “normal”, and the precursor diagnosis level 502 is set to be “execute”. These settings are default settings. As the product inspection diagnosis level 501 changes stepwise from “strict” to “normal” and “lenient”, the size of an abnormality to be detected increases. Minimum sizes detectable at the respective levels are, for example, areas shown in FIG. 7. Note that “strict”, “normal”, and “lenient” are displayed as the product inspection diagnosis level, but these are merely an example, and the product inspection diagnosis level is not limited to them. For example, a diagnosis level may be set between “strict” and “normal”, or “normal”and “lenient”.

In the HDD 216, setting information and image data necessary for various diagnoses are stored. Various kinds of setting information and image data stored in the HDD 216 are reusable. The stacker 109 performs control of discharging a printed print member having passed through the conveyance path to the stack tray, discharging it to the escape tray, or conveying it to the finisher 110 connected downstream in the conveyance direction of the printed print member. The finisher 110 controls conveyance and discharge of printed print members, and performs finishing processing such as stapling, punching, or saddle stitching.

### External Controller 102

The external controller 102 includes a CPU 251, a memory 252, an HDD 253, a keyboard 256, a display unit 254, network I/Fs 255 and 257, and a video I/F 258. These devices are connected so that they can transmit/receive data to/from each other via a system bus 259.

The CPU 251 controls the overall operation of the external controller 102 such as reception of print data from the client PC 103, RIP processing, and transmission of print data to the image formation apparatus 101 by executing programs stored in the HDD 253. In the memory 252, programs and data necessary when the CPU 251 performs various processes are stored. The memory 252 operates as the work area of the CPU 251.

In the HDD 253, various programs and data are stored. The keyboard 256 is used to input an operation instruction from the user to the external controller 102. The display unit 254 is, for example, a display, and is used to display information of an application running in the external controller 102, and an operation screen. The network I/F 255 includes communication modules such as NIC and a wireless circuit, is connected to the client PC 103 via the external LAN 104, and is used for communication of data such as a print instruction. The network I/F 257 includes a communication module such as NIC, is connected to the image formation apparatus 101 via the internal LAN 105, and is used for communication of data such as a print instruction. The external controller 102 is configured to be able to communicate with the printing device 107, the diagnosis device 108, the stacker 109, and the finisher 110 via the internal LAN 105 and the communication cable 260. The video I/F 258 includes a video module, is connected to the image formation apparatus 101 via the video cable 106, and is used for communication of image data (print data).

### Client Pc 103

The client PC 103 includes a CPU 261, a memory 262, an HDD 263, a display unit 264, a keyboard 265, and a network I/F 266. These devices are connected so that they can transmit/receive data to/from each other via a system bus 269. The CPU 261 controls the operation of each device via the system bus 269 by executing a program stored in the HDD 263. Accordingly, various processes by the client PC 103 are implemented. For example, the CPU 261 performs generation of print data and a print instruction by executing a document processing program stored in the HDD 263. In the memory 262, programs and data necessary when the CPU 261 performs various processes are stored. The memory 262 operates as the work area of the CPU 261.

In the HDD 263, programs such as various applications including a document processing program and a printer driver, and various data are stored. The display unit 264 is, for example, a display, and is used to display information of an application running in the client PC 103, and an operation screen. The keyboard 265 is used to input an operation instruction from the user to the client PC 103. The network I/F 266 includes communication modules such as NIC and a wireless circuit, and is able to communicate connected to the external controller 102 via the external LAN 104. The CPU 261 communicates with the external controller 102 via the network I/F 266.

### Product Inspection Diagnosis Processing and Precursor Diagnosis Processing

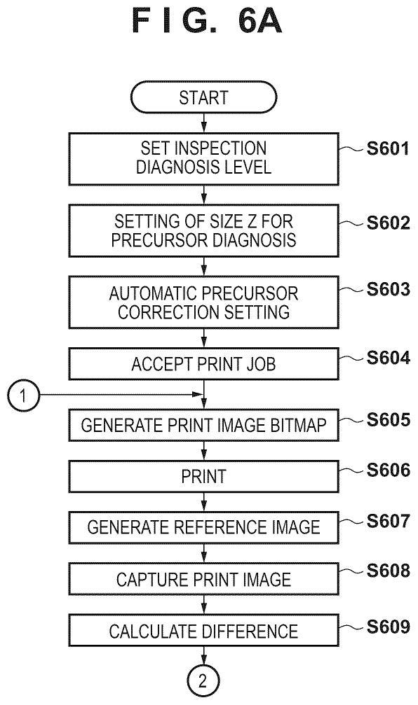

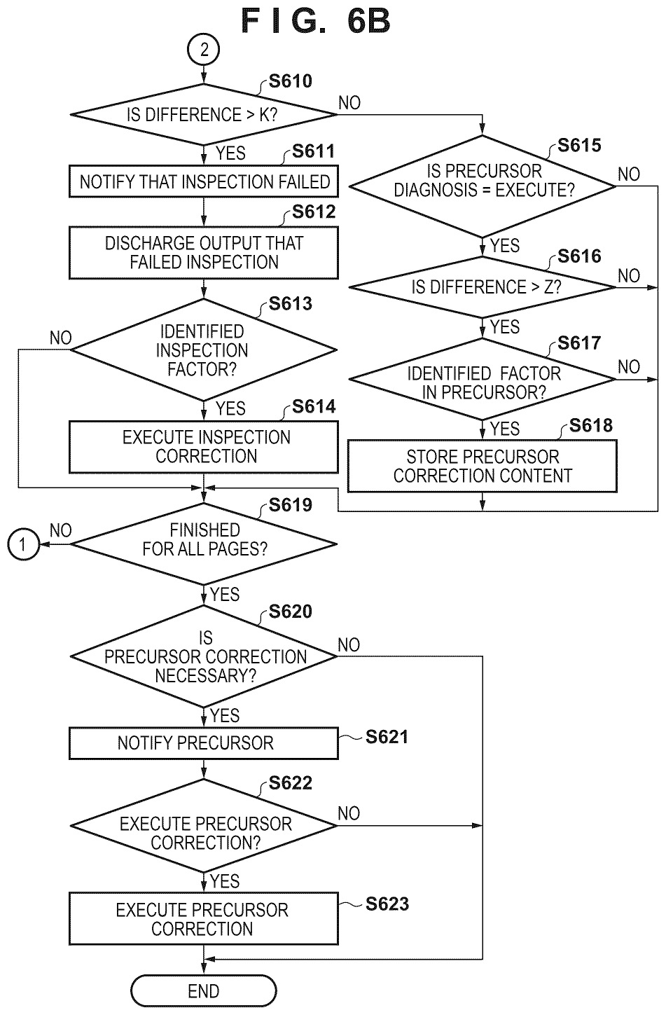

FIGS. 6A and 6B are flowcharts showing the procedures of product inspection diagnosis processing and precursor diagnosis processing that start in response to the print instruction of the printing device 107 and are performed at the time of printing. Note that the processing in FIGS. 6A and 6B are implemented by, for example, reading out and executing programs stored in the memory 207 and the memory 215 by the CPU 206 of the printing device 107 of the image formation apparatus 101 and the CPU 214 of the diagnosis device 108. Also, the processing in FIGS. 6A and 6B are implemented by, for example, reading out and executing a program stored in the memory 252 by the CPU 251 of the external controller 102. Further, the processing in FIGS. 6A and 6B are implemented by, for example, reading out and executing a program stored in the memory 262 by the CPU 261 of the client PC 103. Note that before the start of the processing in FIGS. 6A and 6B, the setting of the precursor diagnosis is “execute”.

In step S601, the CPU 214 of the diagnosis device 108 displays the diagnosis setting screen shown in FIG. 5 in the user mode on the UI display unit 241. The CPU 214 accepts a slide operation of the arrow of the product inspection diagnosis level 501 via the operation unit 242. The CPU 214 sets a level indicated by the arrow as a product inspection diagnosis level. In accordance with the setting of the product inspection diagnosis level, the CPU 214 sets an abnormality detection size K in product inspection, as shown in FIG. 7, and sets the size of an abnormality to be detected.

For example, the arrow of the product inspection diagnosis level 501 indicates “normal”, as shown in FIG. 5. Thus, the CPU 214 sets “normal” as the product inspection diagnosis level. In this case, the abnormality detection size K in product inspection is set to be 1.0 mm². Details of the relationship between the product inspection diagnosis level and the area of the abnormality detection size shown in FIG. 7 will be described later. Note that it has been exemplified that the CPU 214 sets the detection size K from the UI settings of the user mode, but the detection size K may be set from administrator mode settings or service mode settings.

In step S602, the CPU 214 accepts a touch operation to the icon “execute” or the icon “do not execute” of the precursor diagnosis level 502 via the operation unit 242. In the example of FIG. 5, the precursor diagnosis level “execute” is selected. Hence, the CPU 214 accepts a touch operation to the icon “OK” on the diagnosis setting screen shown in FIG. 5, and sets “execute” for the precursor diagnosis. Also, the CPU 214 sets an abnormality detection size Z in precursor diagnosis to a value (for example, 0.5 mm²) smaller than the size K (for example, 1.0 mm²), as shown in FIG. 7.

FIG. 8 exemplifies the shapes of abnormality images at the detection sizes in FIG. 7. When an abnormality is a spot, the diagnosis criterion is, for example, the area of the abnormality shown in FIG. 7. The precursor of the spot is attachment of a toner particle to the drum or the transfer belt. The attached toner acts as a core and grows into a dot, resulting in a spot. When an abnormality is a line (to be also referred to as a streak), the diagnosis criterion of the abnormality is, for example, the length or thickness of the streak. As the diagnosis criterion of a streak, a criterion different from the diagnosis criterion of a spot is set.

The area of a spot changes in accordance with the detection size, as shown in FIG. 8. The size of the detection image of a precursor abnormality is smaller than that of the detection image of a product inspection abnormality because the precursor abnormality is a spot before the spot becomes a product inspection abnormality. Note that the detection size of a product inspection abnormality and that of a precursor abnormality are set separately. That is, the detection size of a product inspection abnormality can be set and changed as the product inspection diagnosis level by the user, as shown in FIG. 5. In contrast, the detection size of a precursor abnormality may be automatically determined in accordance with the product inspection diagnosis level, and the user may not change the setting in principle. However, it may be set that a serviceman skilled in the device can exceptionally change the detection size of a precursor abnormality in the service mode. With this setting, even when a captured image to be diagnosed is an image formed in a device different from the image formation apparatus 101, a diagnosis can be made in correspondence with a difference between the devices. It may also be set that not only a serviceman, but also a skilled user can cope with a difference between the devices by changing the service mode to the user mode so that the setting can be changed in the user mode. Note that a change of the setting of the detection size of a precursor abnormality is restricted so that the detection size of a precursor abnormality does not become larger than that of a product inspection abnormality, in order to detect an abnormality before it becomes a product inspection abnormality.

In step S603, the CPU 214 displays, on a precursor abnormality automatic correction setting screen in the user mode shown in FIG. 19 via the UI display unit 241, whether to automatically correct a factor in a precursor abnormality upon detecting the precursor abnormality. The CPU 214 accepts, via the operation unit 242, a touch operation to an icon 1901 representing to perform automatic correction or an icon 1902 representing not to perform automatic correction. In accordance with the accepted touch operation, the CPU 214 sets automatic correction of a precursor abnormality. Note that the size of a precursor abnormality is a size smaller than a size at which an abnormality (NG) is determined in product inspection diagnosis. In some cases, the factor need not be corrected immediately. On this setting screen, the icon 1902 representing not to perform automatic correction is displayed to be selectable.

In step S604, the CPU 206 of the printing device 107 displays the job management screen as shown in FIG. 4 on the UI display unit 225. The user can touch a print instruction 402 on the job management screen to input a print job. In response to this, the CPU 206 accepts the print job via the operation unit 226. The CPU 206 transmits information of the print job to the external controller 102 via the network I/F 204.

In step S605, the CPU 251 of the external controller 102 receives print job information from the printing device 107 via the network I/F 257. Then, the CPU 251 generates a bitmap for rasterizing and printing a page to be printed. In step S606, the CPU 251 transmits the rasterized bitmap data to the video I/F 205 of the printing device 107 via the video I/F 258 and the video cable 106. The CPU 206 of the printing device 107 receives the bitmap data via the video I/F 205 and prints.

In step S607, as for the rasterized bitmap to be printed, the CPU 214 of the diagnosis device 108 generates a reference image (an example of an “original image”) whose resolution or the like is changed, so as to enable a difference comparison with a print image obtained by capturing a print product in step S608. Note that the reference image may be, for example, a normally printed image as long as the difference between the normally printed image and a diagnosis target image can be compared and the difference (abnormality) can be extracted from the diagnosis target image. The reference image may be generated from a captured image obtained by capturing a normally printed print product by the image capturing units 331 and 332. In step S608, the CPU 214 executes processing of causing the image capturing units 331 and 332 to capture a print product printed in step S606. Then, the CPU 214 stores the captured image as a diagnosis image in the HDD 216 of the diagnosis device 108, and advances to step S609.

In step S609, the CPU 214 compares the reference image and the diagnosis image to generate difference image data for determining an abnormality in the printing device 107. In step S610, the CPU 214 derives the area of the difference from the difference image data in step S609, and determines whether the difference area is larger than the abnormality detection size K in product inspection. If the CPU 214 determines that the difference area is larger than the size K, it determines that the product inspection result is NG (failure), and advances to step S611. To the contrary, if the CPU 214 determines that the difference area is equal to or smaller than the size K, it advances to step S615. Note that when the CPU 214 detects a plurality of differences in the image, it derives difference areas for the respective differences, and determines whether each of the difference areas is larger than the size K. An abnormality for which the product inspection result is NG is an example of an “abnormality of an unacceptable level”.

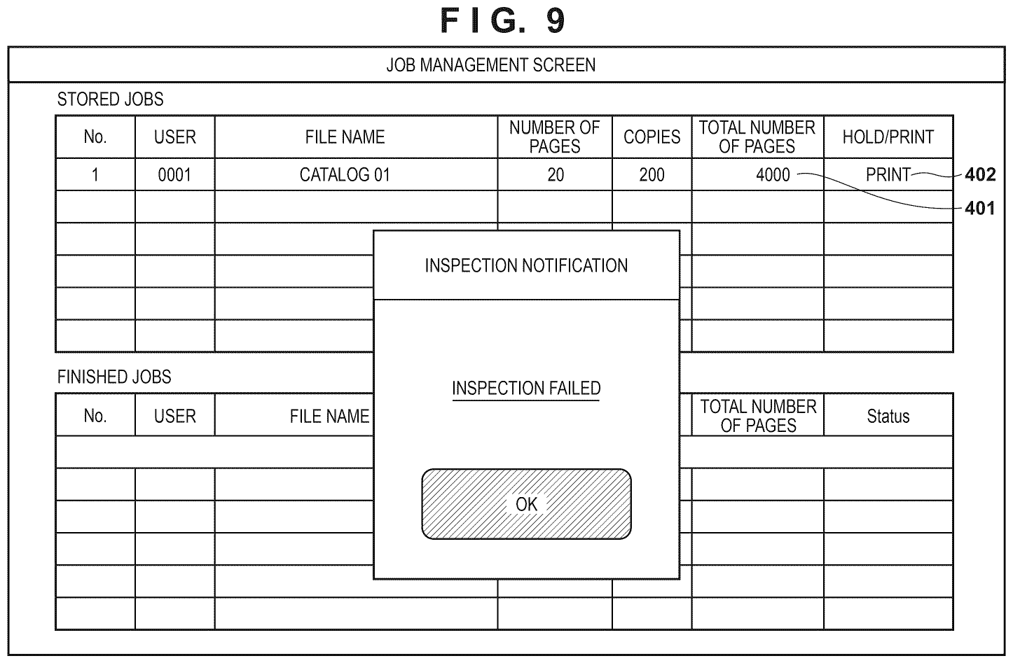

In step S611, the CPU 214 displays, on the job management screen shown in FIG. 4 via the UI display unit 241, a popup representing that the product inspection result is NG (FIG. 9). Note that the display destination of the popup is not limited to the job management screen, and any screen is available as long as the user can recognize that the product inspection result is NG. In step S612, the stacker 109 discharges, to the escape tray 346, a print product that has been conveyed through the conveyance path and that fails product inspection. Note that the stacker 109 discharges, to the stacker tray 341, a print product that has not failed product inspection, or conveys it to the finisher 110 connected downstream in the conveyance direction of the printed print member. The stacker 109 discharges, to the escape tray 346, only print products that fail product inspection, so that the print products that fail product inspection can be discriminated from normal products that are OK in product inspection.

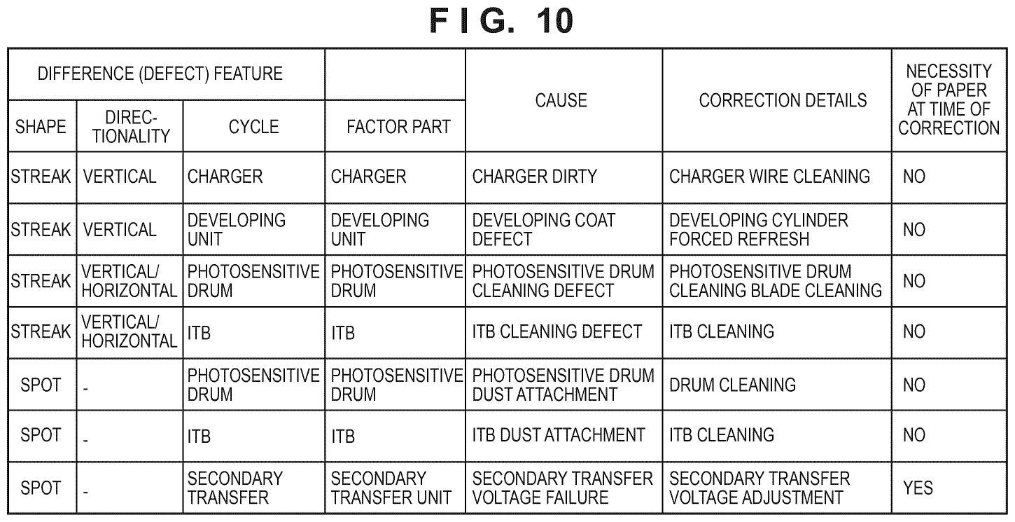

In step S613, the CPU 214 identifies the factor part of the product inspection abnormality based on feature information of the difference region. More specifically, a combination of difference areas of the same color with a high degree of similarity is selected from difference regions, and the part of a factor in the difference and the cause of the difference are identified from cycle information of the selected combination. Note that the feature of a difference region may be the shape, directionality, or the like, other than the cycle. Note that the shape is, for example, a linear shape and a point shape. The directionality is the longitudinal direction and the lateral direction. The cycle is a cycle generated in, for example, the charger, the developing unit, the photosensitive drum, the ITB unit, and secondary transfer. FIG. 10 exemplifies the relationship between a factor part and difference cause corresponding to the feature of such a difference (abnormality), correction contents for correcting the difference, and the necessity of paper when the difference is corrected. Data as shown in FIG. 10 are stored in advance in the memory 215. By referring to the relationship data, the CPU 214 identifies the factor part of a difference, the cause of the difference, correction contents, and the necessity of paper when the difference is corrected.

In step S614, the CPU 214 executes the correction identified in step S613. Note that when the product inspection result is NG in step S613, but the cycle or the like cannot be detected and the factor cannot be identified, the part to be corrected is not identified and no correction is executed.

In step S615, the CPU 214 determines which of “execute” and “do not execute” is set for the precursor diagnosis in step S602. If the CPU 214 determines that the setting of the precursor diagnosis is “execute”, it advances to step S616. If the CPU 214 determines that the setting of the precursor diagnosis is “do not execute”, it advances to step S619. In step S616, the CPU 214 determines whether the difference area derived from the difference image data generated in step S609 is larger than the abnormality detection size Z in precursor diagnosis. If the CPU 214 determines that the difference area is larger than the size Z, it advances to step S617. If the CPU 214 determines that the difference area is equal to or smaller than the size Z, it advances to step S619.

In step S617, the CPU 214 identifies a part as a factor in the precursor of the difference (abnormality) based on the feature information of the difference region. The identifying method is similar to identifying of the factor part of the product inspection abnormality in step S613. By referring to the data shown in FIG. 10, the CPU 214 identifies a part corresponding to the feature of the precursor of the difference, the cause of the precursor of the difference, the correction contents of the precursor abnormality, and the necessity of paper when the difference is corrected.

In step S618, the CPU 214 stores, in the HDD 216, the factor part of the precursor abnormality and the correction contents of the precursor abnormality identified in step S617. In step S619, the CPU 206 determines whether printing of all pages subjected to the print instruction in the print job has ended. If the CPU 206 determines that printing of all pages has ended, it advances to step S620. If the CPU 206 determines that printing of all pages has not ended, it returns to step S605. In step S620, the CPU 214 determines whether the correction contents of the precursor abnormality have been stored in the HDD 216. If the CPU 214 determines that the correction contents of the precursor abnormality have been stored, it determines whether the correction is actually necessary. If the CPU 214 determines that the correction is actually necessary, it advances to step S621. If the CPU 214 determines that no correction is actually necessary, it ends the processing of the flowchart.

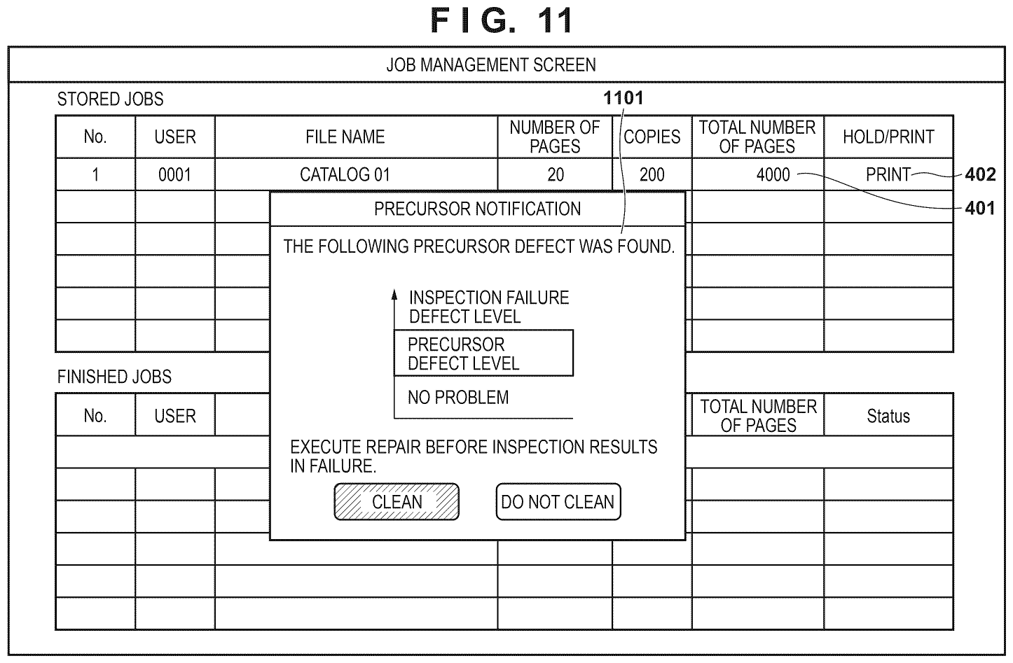

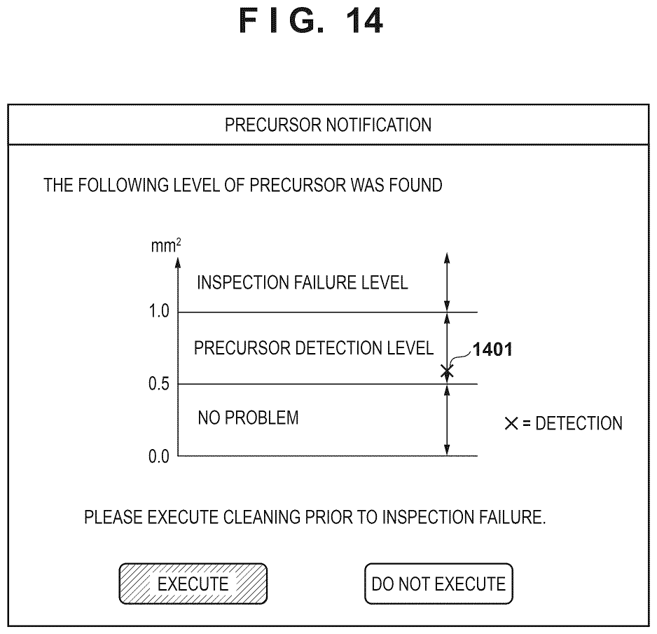

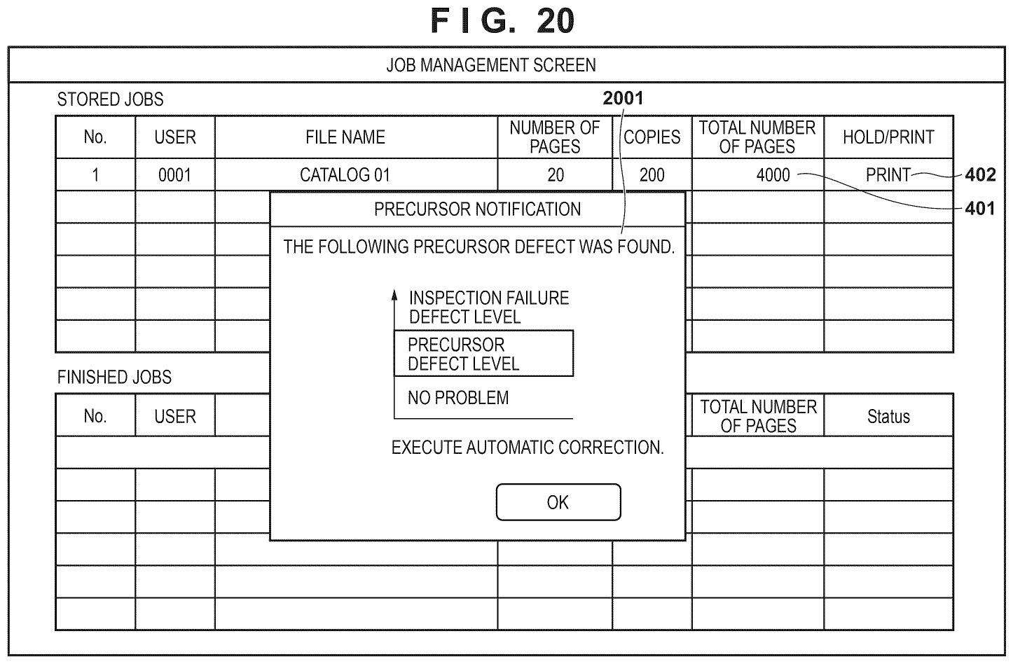

In step S621, the CPU 214 notifies the printing device 107 via the communication I/F 211 of the fact that the precursor abnormality has been detected, and the correction contents of the precursor abnormality. In the printing device 107, the CPU 206 receives, via the communication I/F 201, the fact that the precursor abnormality has been detected, and the correction contents of the precursor abnormality. The CPU 206 displays, over the job management screen displayed on the UI display unit 225, a popup representing the fact that the precursor abnormality has been detected, and prompting correction of the precursor abnormality (FIG. 11). The CPU 206 displays an icon capable of selecting whether to execute correction. Note that when automatic correction is set in step S603, a popup representing that automatic correction is executed is displayed over the job management screen, as shown in FIG. 20. Note that the screen on which these popups are displayed is not limited to the job management screen, and can be a precursor notification screen (for example, FIG. 14) capable of notifying the user that a precursor abnormality has been detected. Note that the UI display unit 225 is an example of the “display I/F”.

In step S622, the CPU 206 determines whether an icon representing to execute correction has been touched on the job management screen shown in FIG. 11. If the CPU 206 determines that the icon has been touched, it advances to step S623. If the CPU 206 determines that the icon has not been touched, it ends the processing of the flowchart. Alternatively, the CPU 206 determines whether an OK icon representing that execution of automatic correction is approved has been touched on the job management screen shown in FIG. 20. If the CPU 206 determines that the icon has been touched, it advances to step S623. If the CPU 206 determines that the icon has not been touched, it ends the processing of the flowchart. In step S623, the CPU 206 performs control of executing the correction contents. Then, the CPU 206 ends the processing of the flowchart.

Depending on the correction contents, the execution and end of correction can or cannot be automatically detected. For example, when the correction contents are cleaning work of the charger wire, it is difficult to determine whether the correction has been executed, because the wire shape does not change. Even when input/output of a part to be cleaned is detected, it is difficult to determine whether the cleaning work has actually been executed. Hence, automatic detection by the sensor is hard. However, such correction contents can be determined by the user. The CPU 206 thus may display a confirmation screen capable of manually selecting whether cleaning has been executed, as shown in FIG. 13. The CPU 206 accepts a touch operation to an icon “cleaning executed” or an icon “cleaning not yet executed” via the operation unit 226. If the CPU 206 accepts an operation to the icon “cleaning executed”, it ends the processing of the flowchart.

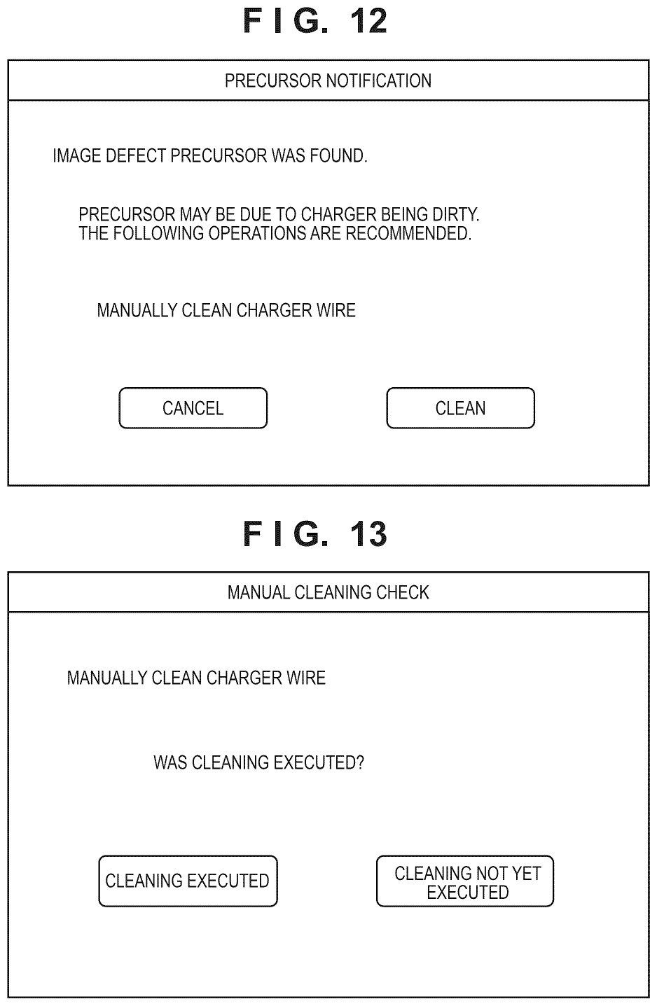

In contrast, if the CPU 206 accepts an operation to the icon “cleaning not yet executed” on the confirmation screen shown in FIG. 13, this indicates that the precursor abnormality has been detected as shown in FIG. 12, and a screen prompting cleaning is displayed. Then, the CPU 206 accepts a touch operation to an icon “clean” or an icon “cancel” via the operation unit 226. If the CPU 206 accepts an operation to the icon “clean”, it actually executes cleaning and ends the processing of the flowchart. If the CPU 206 accepts an operation to the icon “cancel”, it ends the processing of the flowchart without executing cleaning.

### Correction Contents

The relationship between the factor part and difference cause of a difference (abnormality), the correction contents for correcting the difference, and the necessity of paper when the difference is corrected will be explained with reference to FIG. 10. The CPU 214 of the diagnosis device 108 detects, from a difference image, the shape of a difference, the directivity of the shape, and the cycle of the difference. By looking up the table information shown in FIG. 10, the CPU 214 identifies the factor part and cause of the difference corresponding to the difference image.

More specifically, the CPU 214 detects that, for example, a streak is generated in the lateral direction in a difference image and the cycle is that of the photosensitive drum. Such detection is implemented using, for example, a known image processing method. Note that the streak is, for example, an abnormality linearly attached to the drum, the belt, or the like. By looking up the table shown in FIG. 10, the CPU 214 identifies that the factor part is the photosensitive drum and the cause is a cleaning failure of the photosensitive drum. As the correction contents, the CPU 214 determines cleaning of the cleaning blade of the photosensitive drum. Then, the printing device 107 executes cleaning of the cleaning blade of the photosensitive drum, as described above. In this manner, the correction of the cleaning blade of the photosensitive drum is executed.

As another example, the CPU 214 detects that a spot is generated in a difference image and the cycle is that of the photosensitive drum. By looking up the table shown in FIG. 10, the CPU 214 identifies that the factor part is the photosensitive drum and the cause is attachment of dust to the photosensitive drum. As the correction contents, the CPU 214 determines cleaning of the photosensitive drum. Then, the printing device 107 executes cleaning of the photosensitive drum, as described above. In this fashion, the correction of the photosensitive drum is executed.

The cause of an abnormality is identified from the shape, directivity, cycle, or the like of a difference (abnormality) in a difference image, correction contents suited to the cause are selected, and correction is executed. Note that the contents of the table in FIG. 10 are merely part of the correction contents, and the correction contents are not limited to this.

### Patterns of Product Inspection Abnormality and Precursor Abnormality

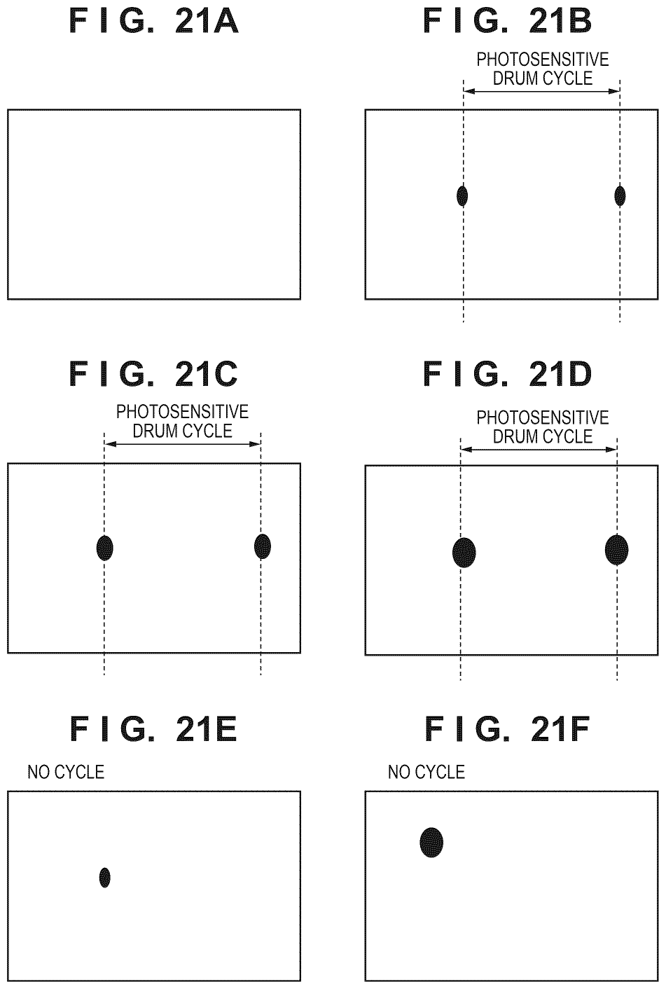

The patterns of a product inspection abnormality and precursor abnormality formed on a print product will be explained with reference to FIGS. 21A to 21F. FIG. 21A shows a print product printed by a printing machine in an initial state. Such a print product is diagnosed not to be NG in product inspection diagnosis, and is also diagnosed not to have any precursor in precursor diagnosis. FIG. 21B shows a print product which is diagnosed not to be NG in product inspection diagnosis but on which a precursor is detected in precursor diagnosis. On the print product, two precursor abnormalities are formed in a predetermined cycle by the photosensitive drum. Thus, the precursor correction of the photosensitive drum is executed. After that, a print product printed by the printing machine changes basically to a state as shown in FIG. 21A. If no precursor correction of the photosensitive drum is executed, the precursor abnormality grows as shown in FIG. 21C.

When no precursor correction is executed after printing the print product shown in FIG. 21C, the abnormality formed on the print product further enlarges as shown in FIG. 21D, and the print product is diagnosed to be NG in product inspection diagnosis. The CPU 214 of the diagnosis device 108 calculates the cycle of the abnormality and identifies the factor part by referring to data as shown in FIG. 10. Then, the correction of the part is executed.

FIG. 21E exemplifies a print product that is not NG in product inspection diagnosis and does not have any precursor. However, this print product is not in the initial state, unlike the print product shown in FIG. 21A, and one precursor abnormality is formed. When one precursor abnormality is formed like this, the cyclicity of the abnormality cannot be identified. Even if the CPU 214 refers to the data as shown in FIG. 10, a factor in the precursor cannot be identified. Therefore, the precursor abnormality is not announced, and it is determined that there is no precursor. FIG. 21F exemplifies a print product that is NG in product inspection diagnosis and does not have any precursor. This print product is not in the initial state, unlike the print product shown in FIG. 21A, and an abnormality of a size equal to or larger than an area set at the product inspection diagnosis level is formed. However, the number of abnormalities is one, and no cyclicity can be identified. Even if the CPU 214 refers to the data as shown in FIG. 10, a factor in the product inspection abnormality cannot be identified. No correction is therefore executed after the product inspection diagnosis.

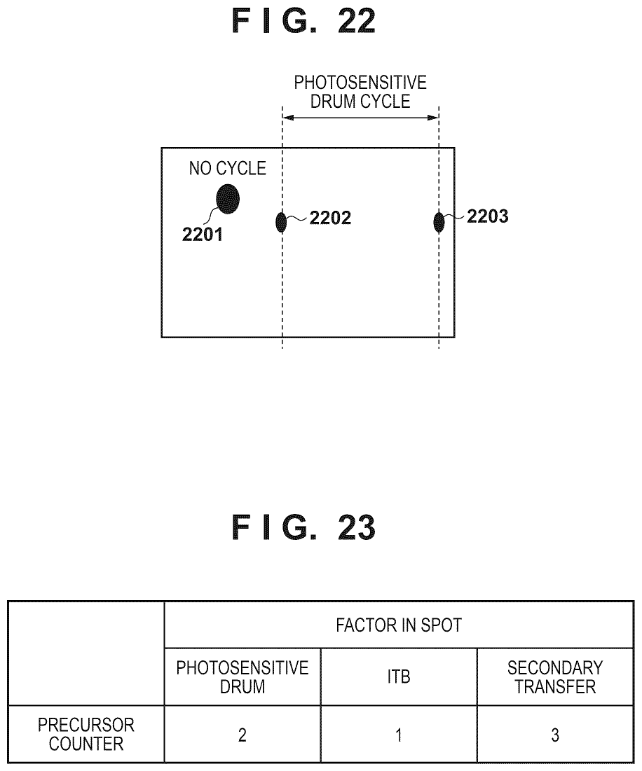

FIG. 22 exemplifies a print product that is NG in product inspection diagnosis and has a precursor. On this print product, a product inspection abnormality and a precursor abnormality exist within one page. The number of abnormalities is not limited to one within one page. A product inspection abnormality 2201 is an abnormality of a size equal to or larger than an area set at the product inspection diagnosis level, but the cyclicity of one product inspection abnormality 2201 cannot be identified. Even by referring to the data as shown in FIG. 10, a factor in the product inspection abnormality cannot be identified. Hence, no correction is executed after the product inspection diagnosis. To the contrary, a factor part corresponding to the cycle of precursor abnormalities 2202 and 2203 formed on the print product can be identified by referring to the data as shown in FIG. 10. The correction of the factor part of the precursor abnormalities 2202 and 2203 can be executed. Note that when a plurality of abnormalities exist within one page, they are not limited to an abnormality caused by the photosensitive drum. For example, a plurality of abnormalities can be formed by even the operation of the charger or developing unit. Even in this case, processing similar to that for the photosensitive drum can be executed.

### Precursor Notification

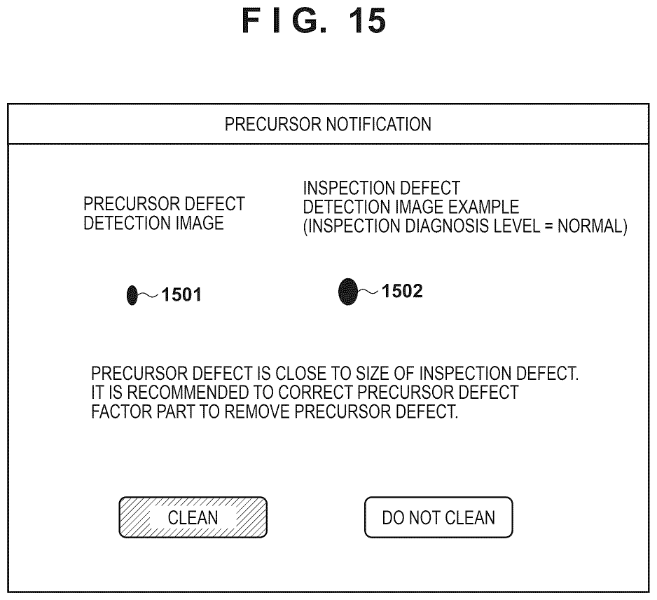

A notification screen when an abnormality is detected in precursor diagnosis will be exemplified with reference to FIGS. 11, 12, 14, and 15. A precursor notification screen shown in FIG. 11 is displayed when the area of an abnormality formed on a print product changes from a size smaller than the detection size of a precursor abnormality to a size equal to or larger than the detection size. The screen in FIG. 12 prompts manual cleaning when a precursor abnormality caused by smudging of the charger is detected. As another example, in FIG. 14, when an abnormality is detected in precursor diagnosis, the area of the precursor abnormality is calculated, and the position of a mark 1401 (×) is changed and displayed in accordance with the calculated area. Note that the area of a precursor abnormality may be calculated by a known image processing method. As still another example, a screen in FIG. 15 displays an abnormality image 1501 actually detected in precursor diagnosis, displays next to the abnormality image 1501 an abnormality image 1502 detected in product inspection diagnosis, and notifies the user that the precursor abnormality comes close to the size of a product inspection abnormality. Note that the precursor notification screens in FIGS. 14 and 15 are examples of displaying “the degree of an abnormality”. The precursor notification screen in FIG. 14 is an example of “quantitatively displaying an abnormality” and “displaying the area of an abnormality”. The precursor notification screen in FIG. 15 is an example of “displaying the shape of an abnormality”.

### Operation Effects

The printing system 100 as described above displays the precursor notification screen as shown in FIG. 14, and the user can quantitatively grasp the size of a precursor abnormality. Alternatively, the printing system 100 as described above displays the precursor notification screen as shown in FIG. 15, and the user can relatively grasp the size of a precursor abnormality by comparing it with the size of a product inspection abnormality displayed on the same screen. The user can recognize the degree of the precursor, and execute correction, cleaning, or the like of a part at a proper timing. This suppresses detection of an abnormality exceeding the criterion in product inspection in the next job after diagnosis. As a result, it can be prevented that a print product fails product inspection diagnosis, a failing image-formed sheet is discarded, and toner for forming the image is wastefully used.

### Second Embodiment

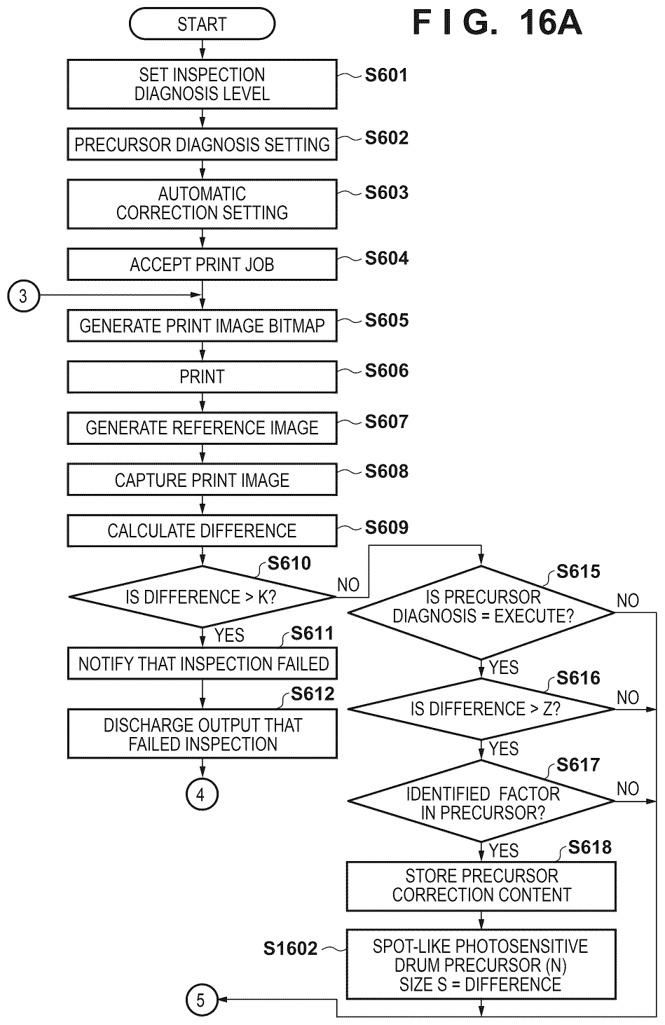

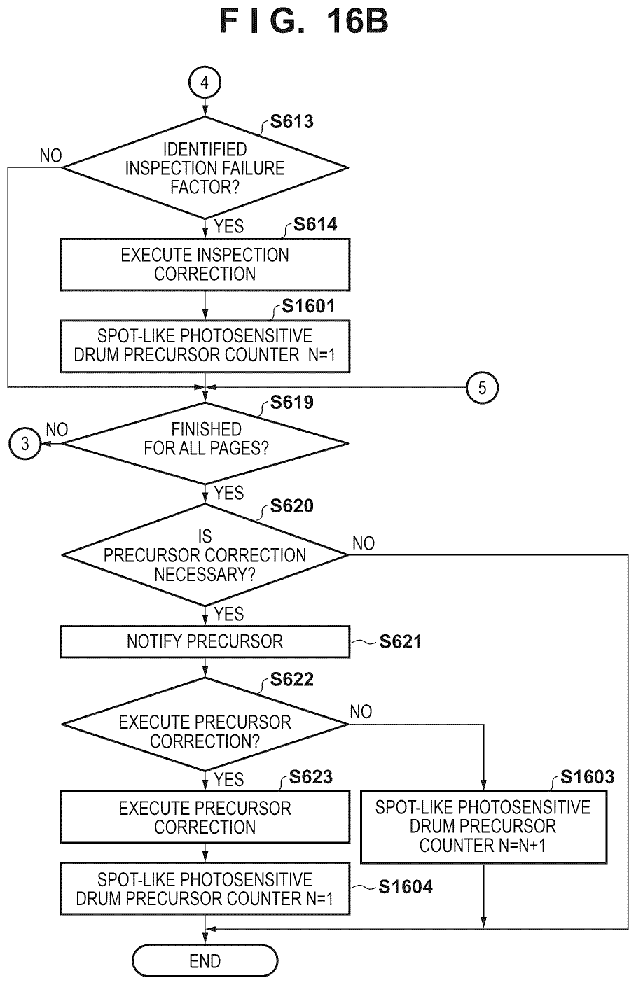

The flowchart of processing of, when the factor part of a precursor abnormality has not been corrected and the abnormality is detected in the next precursor diagnosis, displaying the precursor abnormality and the previous precursor abnormality on a precursor notification screen will be explained with reference to FIGS. 16A and 16B. Note that the same reference numerals denote processes common to those in FIGS. 6A and 6B, and a description thereof will not be repeated. The processing in FIGS. 16A and 16B are implemented by, for example, reading out and executing programs stored in a memory 207 and a memory 215 by a CPU 206 of a printing device 107 of an image formation apparatus 101 and a CPU 214 of a diagnosis device 108. Also, the processing in FIGS. 16A and 16B are implemented by, for example, reading out and executing a program stored in a memory 252 by a CPU 251 of an external controller 102. Further, the processing in FIGS. 16A and 16B are implemented by, for example, reading out and executing a program stored in a memory 262 by a CPU 261 of a client PC 103. Note that before the start of the processing in FIGS. 16A and 16B, the setting of the precursor diagnosis is “execute”. Before the start of the sequence in FIGS. 16A and 16B, the counter of the precursor of a spot formed by the photosensitive drum is initialized to N=1.

In step S613, the CPU 214 of the diagnosis device 108 determines, by using data as shown in FIG. 10, whether the factor part of an abnormality in product inspection diagnosis can be identified. Here, assume that the CPU 214 identifies that the shape of an abnormality formed on a print product is a spot in product inspection diagnosis and the factor part is the photosensitive drum. In step S614, the CPU 214 executes the correction contents of the photosensitive drum that forms the spot identified in step S613. More specifically, the CPU 214 notifies the printing device 107 of the correction contents via a communication I/F 211. The CPU 206 of the printing device 107 receives the correction contents via a communication I/F 201, and executes it. Then, a factor in the formation of a spot on the photosensitive drum is removed, and a spot exceeding the product inspection diagnosis level and the precursor diagnosis level will not be generated. After that, the process advances to step S1601. In step S1601, the CPU 214 of the diagnosis device 108 initializes the counter N to 1, and advances to step S619.

In step S617, the CPU 214 of the diagnosis device 108 determines, by using the data as shown in FIG. 10, whether the factor part of an abnormality in precursor diagnosis can be identified. Here, assume that the CPU 214 identifies that the shape of an abnormality formed on a print product is a spot in precursor diagnosis and the factor part is the photosensitive drum. Thereafter, the process sequentially advances to steps S618 and S1602. In step S1602, if the spot-like precursor abnormality whose factor part is the photosensitive drum is detected for the first time after correction (replacement) of the previous photosensitive drum, the counter N is set to be 1. Thus, the CPU 214 of the diagnosis device 108 sets, for example, 0.6 mm² as a size S of a spot-like precursor abnormality (1) whose factor is the photosensitive drum. Then, the process sequentially advances to steps S619, S620, and S621.

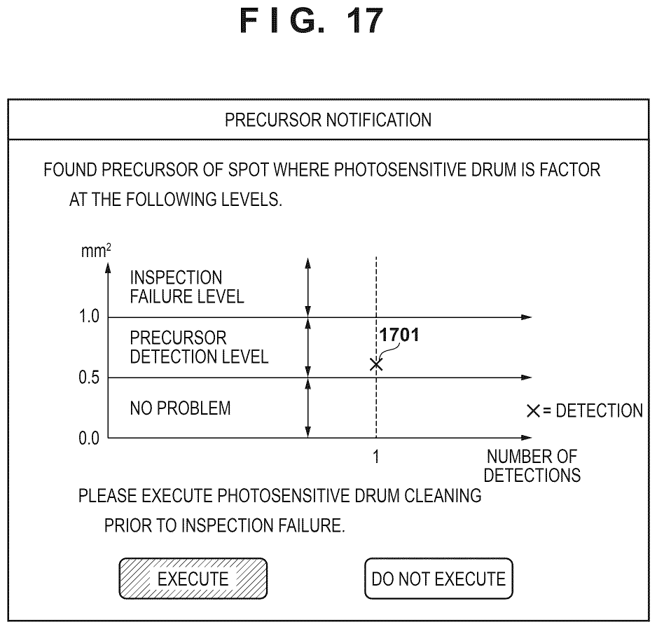

In step S621, the CPU 214 of the diagnosis device 108 notifies the printing device 107 of the precursor via the communication I/F 211. The CPU 206 of the printing device 107 receives the precursor via the communication I/F 201. The CPU 206 displays a precursor notification screen shown in FIG. 17 on a job management screen shown in FIG. 4, and notifies the user that the precursor has been detected. The precursor notification screen shown in FIG. 17 displays a graph in which the detection count of a precursor abnormality is plotted along the abscissa and the area of the precursor abnormality is plotted along the ordinate. This graph also displays a dotted line representing a NG diagnosis level in product inspection diagnosis, and a level at which a precursor abnormality is detected in precursor diagnosis. In step S1602, N is set to be 1. A × mark is plotted at a position 1701 at which the detection count is 1 and which corresponds to the size S (0.6 mm²) of the precursor abnormality (1). Note that the precursor notification screen is displayed on the job management screen, but may be displayed on another screen as long as it can notify the user that a precursor has been detected.

The CPU 206 displays, on the precursor notification screen shown in FIG. 17, an icon “execute” and icon “do not execute” cleaning of the photosensitive drum. If the CPU 206 accepts via an operation unit 226 in step S622 a touch operation to the icon “execute” cleaning of the photosensitive drum, it transmits a message to this effect to the diagnosis device 108. If the value of the counter N is smaller than a predetermined value, the CPU 214 of the diagnosis device 108 determines that the precursor diagnosis level is in the initial state, and advances to step S1603. Also, if the CPU 206 accepts via the operation unit 226 a touch operation to the icon “do not execute” cleaning of the photosensitive drum, it advances to step S1603. In contrast, if the CPU 214 determines that the value of the counter N is larger than the predetermined value, or the CPU 206 accepts via the operation unit 226 a touch operation to the icon “execute” cleaning of the photosensitive drum, the process advances to step S623.

In step S1603, the CPU 214 of the diagnosis device 108 increments the counter N by one so that the size of a spot-like precursor abnormality whose factor is the photosensitive drum and which will be detected next time can be stored. The CPU 214 ensures, in the memory 215 or the like, a storage area of the size S of the (N+1)th precursor abnormality. After that, the sequence shown in FIGS. 16A and 16B ends. In step S623, the CPU 214 of the diagnosis device 108 notifies the printing device 107 of the correction contents of the precursor set in step S615. The CPU 206 of the printing device 107 executes the correction contents, and advances to step S1604. Since the correction of the photosensitive drum has been executed in step S623 and a factor in the spot-like precursor abnormality has been removed, the CPU 214 of the diagnosis device 108 initializes the counter N to 1 in step S1604, and ends the sequence shown in FIGS. 16A and 16B.

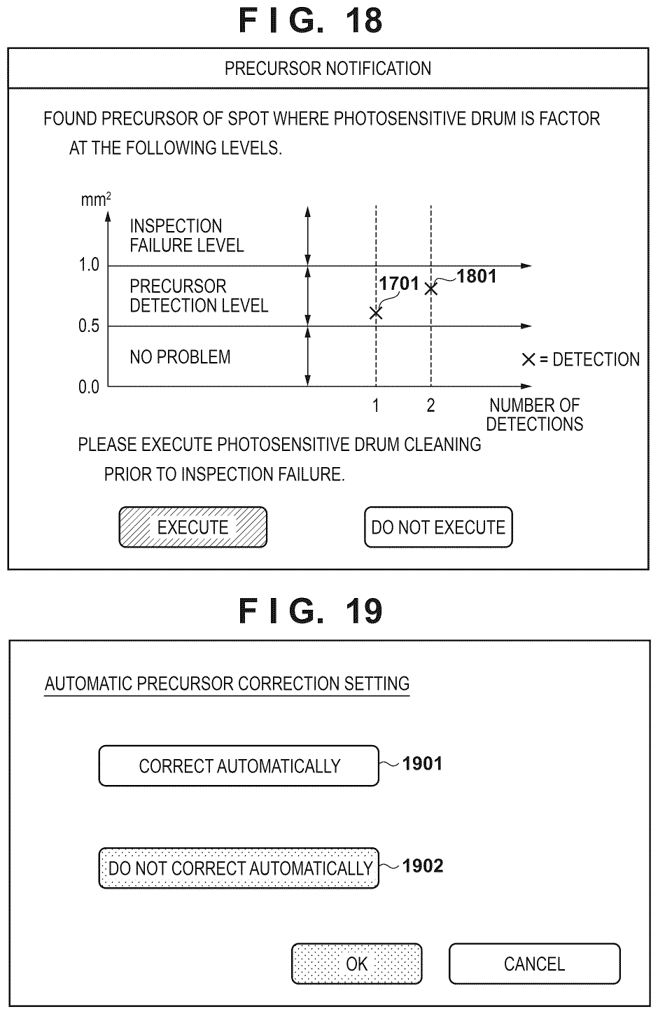

If the factor part of the precursor abnormality has not been corrected and step S623 has not been executed, the counter N is set to be 2 in step S1603. In this case, if a spot-like precursor abnormality whose factor is the photosensitive drum is detected in the next diagnosis, the CPU 214 of the diagnosis device 108 sets the size S of a precursor abnormality (2) to be, for example, 0.7 mm² in step S1602. In step S621, the CPU 214 of the diagnosis device 108 notifies the printing device 107 of the precursor via the communication I/F 211. The CPU 206 of the printing device 107 receives the precursor via the communication I/F 201. The CPU 206 displays a precursor notification screen shown in FIG. 18 on the job management screen shown in FIG. 4, and notifies the user that the second precursor has been detected.

On the precursor notification screen shown in FIG. 18, N is set to be 2, so a × mark is plotted at a position 1801 at which the detection count is 2 and which corresponds to the size S (0.7 mm²) of the precursor abnormality (2), in addition to the screen shown in FIG. 17. The position 1801 is provided above the position 1701 shown in FIG. 17 on the screen. The user can recognize that the size of the second precursor abnormality becomes larger than that of the first precursor abnormality. The user can also recognize that the size of the second precursor abnormality comes close to a level at which NG is determined in product inspection diagnosis. Compared to the first precursor notification, the user is more likely to execute correction of the photosensitive drum which is a factor in the precursor abnormality. Before the print product fails product inspection diagnosis, correction of the photosensitive drum can be executed to remove a factor in the precursor abnormality. It can therefore be prevented that a print product fails product inspection diagnosis before it happens, a sheet bearing an image that fails product inspection is discarded, and toner for forming the image is wastefully used. Note that the precursor notification screens in FIGS. 17 and 18 are examples of displaying “the degree of an abnormality”, displaying “an abnormality quantitatively”, displaying “an abnormality over time”, and displaying “the area of an abnormality”.

Note that the detection count is used as a parameter on the precursor notification screen displayed in step S621. However, the parameter suffices to represent a time-series change of the size S, instead of the detection count, and may be, for example, the number of print sheets for which a correction target part is used. It is also possible that, for each detection count, the number of print sheets that will fail product inspection diagnosis is predicted using the number of print sheets for which the part is used, and the predicted number of print sheets is used as the parameter.

In the flowchart shown in FIGS. 16A and 16B, the transition of a size corresponding to a detection count in precursor diagnosis is displayed in FIGS. 17 and 18 for a spot-like precursor abnormality whose factor is the photosensitive drum. However, as for a part other than the photosensitive drum, the transitions of respective sizes corresponding to the detection counts of spot-and streak-like precursor abnormalities may be displayed. That is, counters N may be prepared for the causes of respective spot-and streak-like precursor abnormalities. For the respective precursor abnormalities, determination processing may be executed in the sequence of FIGS. 16A and 16B. Marks corresponding to the areas of the respective precursor abnormalities may be plotted on the precursor notification screen shown in FIG. 17. FIG. 23 is a table showing that the photosensitive drum, the ITB, and the secondary transfer unit are identified as factor parts of a spot-like precursor abnormality and counters N are provided for the respective factor parts. According to this disclosure, the user can determine whether to execute correction of an individual part, by referring to the correction possible/impossible state of each part.

### Operation Effects

The printing system 100 according to the second embodiment displays a precursor notification screen as shown in FIGS. 17 and 18, and the user can recognize the size of a precursor abnormality for each detection count. Since the size of the precursor abnormality changes over time, the user can recognize that the precursor abnormality comes close to a diagnosis level at which a print product fails product inspection diagnosis. Hence, the user can recognize the degree of the precursor, and execute correction, cleaning, or the like of a part at a proper timing. This suppresses detection of an abnormality exceeding the criterion in product inspection in the next job after diagnosis. It can be prevented that a sheet bearing an image that is NG in product inspection diagnosis is discarded, and toner for forming the image is wastefully used.

### Modification

In step S607, the image formation apparatus 101 may receive, via the external LAN 104 and the internal LAN 105, a reference image generated outside the image formation apparatus 101. In step S608, the CPU 214 may receive, via the external LAN 104 and the internal LAN 105, a diagnosis image captured outside the image formation apparatus 101. In step S618, the CPU 206 may transmit an identified part and correction contents to the client PC 103 via the external LAN 104 and the internal LAN 105. The client PC 103 may transmit a correction instruction including the correction contents via a network to the image formation apparatus 101.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-150232, filed Aug. 30, 2024, which is hereby incorporated by reference herein in its entirety.

What is claimed is:

1. An inspection system including a controller that, in an inspection of comparing a captured image obtained by capturing a print product generated by an image formation device and a reference image, determines whether the captured image is normal or a failure, the system comprising a display I/F that, in a state in which a quality of the print product by the image formation device degrades even in a case where a result of the inspection is normal, announces occurrence of the state and a count at which the state has occurred.

2. The inspection system according to claim 1, wherein the display I/F displays, over time on a screen, a factor determined to be in the state in which the quality of the print product degrades.

3. The inspection system according to claim 1, wherein the display I/F displays, on a screen, one of an area and shape of a factor determined to be in the state in which the quality of the print product degrades.

4. The inspection system according to claim 1, wherein the controller further diagnoses whether a factor determined to be in the state in which the quality of the print product degrades is a factor in an unacceptable level, and
the display I/F displays, on a screen, a first criterion for diagnosing a factor in the unacceptable level and a second criterion for diagnosing the factor determined to be in the state in which the quality of the print product degrades.

5. The inspection system according to claim 4, wherein the second criterion is set to be stricter than the first criterion, and is set within a range of a determination ability of the factor determined by the controller to be in the state in which the quality of the print product degrades.

6. The inspection system according to claim 1, wherein the display I/F further outputs, in a selectable manner, whether to automatically execute removal of the factor determined to be in the state in which the quality of the print product degrades.

7. The inspection system according to claim 4, further comprising a scanner that captures an image formed on the print product,
wherein the controller diagnoses, by using a difference between an original image of the image before the image is formed on the print product and the image captured by the scanner, whether the factor in the unacceptable level and the factor determined to be in the state in which the quality of the print product degrades exist in the image captured by the scanner.

8. The inspection system according to claim 1, wherein in the state in which the quality of the print product degrades, the display I/F further outputs contents of executing removal of the factor determined to be in the state in which the quality of the print product degrades.

9. A control method of an inspection system including a controller that, in an inspection of comparing a captured image obtained by capturing a print product generated by an image formation device and a reference image, determines whether the captured image is normal or a failure, the method comprising displaying, in a state in which a quality of the print product by the image formation device degrades even in a case where a result of the inspection is normal, a notification of occurrence of the state and a count at which the state has occurred.
